(19) United States
(12) Patent Application Publication
(10) Pub. No.: US 2014/0183331 A1
(43) Pub. Date: Jul. 3, 2014

(54) PHOTOELECTRIC CONVERSION MODULE

(71) Applicant: HON HAI PRECISION INDUSTRY CO., LTD., New Taipei (TW)

(72) Inventor: YI-ZHONG SHEU, New Taipei (TW)

(73) Assignee: HON HAI PRECISION INDUSTRY CO., LTD., New Taipei (TW)

(21) Appl. No.: 13/968,419

(22) Filed: Aug. 15, 2013

(30) Foreign Application Priority Data
Dec. 27, 2012 (TW) 101150701

(51) Int. Cl. G01J 1/02

(52) U.S. Cl. CPC G01J 1/0204
USPC 250/206

(57) ABSTRACT

A photoelectric conversion module includes a lens unit, a circuit board, and a photoelectric unit. The lens unit is positioned on the circuit board. The photoelectric unit is connected electrically with the circuit board and is optically coupled with the lens unit. A groove is defined on the circuit board. The photoelectric unit is located in the groove.

### BACKGROUND

1. Technical Field

The present disclosure relates to photoelectric conversion modules, and particularly, to a photoelectric conversion module having smaller thickness.

2. Description of Related Art

Photoelectric conversion modules generally include a lens unit, a photoelectric unit, and a circuit board. A groove is defined in the lens unit, thus a holding house between the lens unit and the circuit board is generated. The photoelectric unit is located in the holding house and electrically connected with the circuit board. In this structure, the lens unit may have a larger thickness, and thus, the photoelectric conversion module has a larger thickness.

Therefore, it is desirable to provide a photoelectric conversion module, which can overcome the limitation described.

### BRIEF DESCRIPTION OF THE DRAWINGS

The components of the drawings are not necessarily drawn to scale, the emphasis instead being placed upon clearly illustrating the principles of the embodiments of the present disclosure. Moreover, in the drawings, like reference numerals designate corresponding parts throughout several views.

FIG. 1 is a schematic, sectional view of a photoelectric conversion module, according to an embodiment.

FIG. 2 is another schematic, sectional view of the photoelectric conversion module.

### DETAILED DESCRIPTION

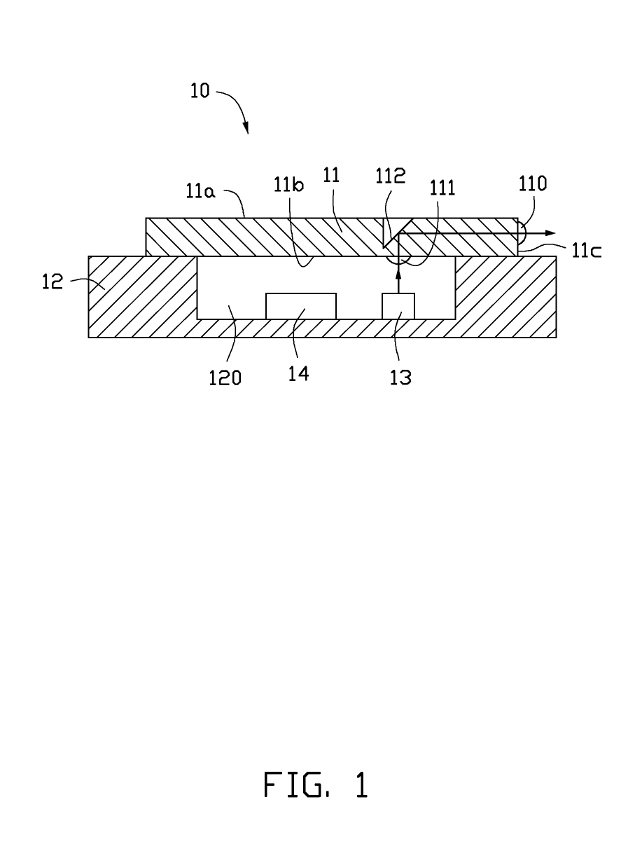

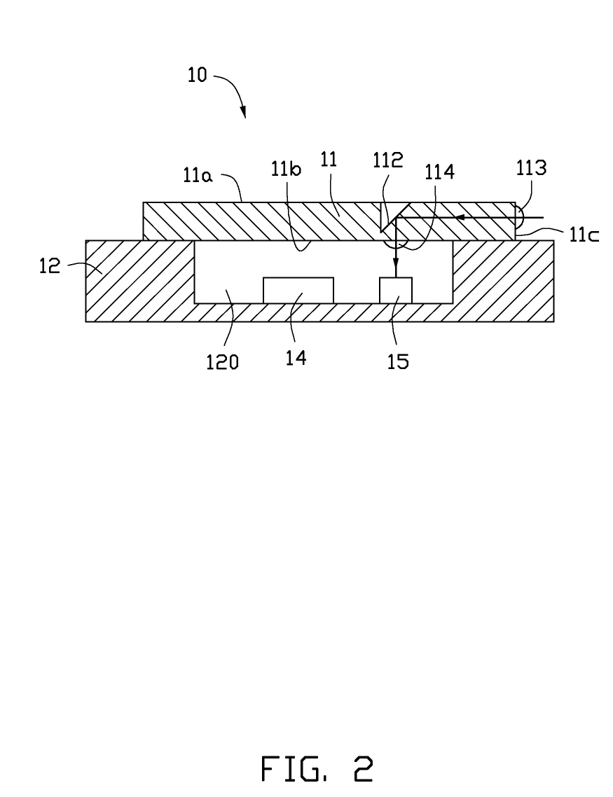

FIGS. 1-2 show a photoelectric conversion module 10, in accordance with one embodiment.

The photoelectric conversion module 10 includes a lens unit 11, a circuit board 12, a light-emitting component 13, a processor 14, and a light receiver 15. The light-emitting component 13 can be a light-emitting diode. The light receiver 15 can be a photo diode. The light-emitting component 13 and the light receiver 15 are collectively named as photoelectric unit.

The lens unit 11 can be located on the circuit board 12 by glue. The lens unit 11 includes a first surface 11a, a second surface 11b opposite to the first surface 11a, and a third surface 11c. The third surface 11c is perpendicular to the first surface 11a and the second surface 11b. The lens unit 11 includes a first lens 110, a second lens 111, a reflecting surface 112, a third lens 113, and a fourth lens 114. Both the first lens 110 and the third lens 113 are positioned on the third surface 11c. The second lens 111 and the fourth lens 114 are positioned on the second surface 11b. The reflecting surface 112 obliquely extends from the first surface 11a towards the second surface 11b.

The number of the first lens 110 is equal to the number of the second lens 111. The number of the third lens 113 is equal to the number of the fourth lens 114. The total number of the first lens 110 and the third lens 113 is equal to the total number of the second lens 111 and the fourth lens 114. The total number of the first lens 110 and the third lens 113 is equal to the total number of the light-emitting component 13 and the light receiver 15.

In this embodiment, the number of each of the first lens 110, the second lens 111, the third lens 113, and the fourth lens 114 is one.

An optical axis of the fourth lens 114 is parallel with an optical axis of the second lens 111. The optical axes of the fourth lens 114 and the second lens 111 are on a first plane. An optical axis of the first lens 110 is parallel with an optical axis of the third lens 113. The optical axes of the first lens 110 and the third lens 113 are on a second plane. The first plane is perpendicular to the second plane. The optical axis of the first lens 110 is parallel with the circuit board 12 and the optical axis of the second lens 111 is perpendicular to the circuit board 12. The included angle between the optical axis of the first lens 110 and the reflecting surface 112 is 45 degrees and the included angle between the optical axis of the second lens 111 and the reflecting surface 112 is also 45 degrees.

The optical axis of the first lens 110 is perpendicular to and intersects with that of the second lens 111. The optical axis of the third lens 113 is perpendicular to and intersects with that of the fourth lens 114.

A groove 120 is defined in the circuit board 12. The light-emitting component 13, the processor 14, and the light receiver 15 are located in the groove 120. Both the second lens 111 and the fourth lens 114 face the groove 120.

The processor 14 is electrically connected with the light-emitting component 13 and the light receiver 15 in order to control them.

The circuit board 12 can be made of the material having good radiating performance, for example, ceramic.

Light emitted from the light-emitting component 13 passes through the second lens 111 and shines onto the reflecting surface 112. The light is reflected by the reflecting surface 112 and then exits from first lens 111 of the lens unit 11. Light passing through the third lens 113 shines onto the reflecting surface 112 and is reflected by the reflecting surface 112, then exits from the fourth lens 114. The light receiver 15 receives the light exited from the fourth lens 114. The reflecting surface 112 changes the shined light 90 degrees.

The groove 120 is defined on the circuit board 12 and configured for holding the light-emitting component 13, the processor 14, and the light receiver 15. The lens unit 12 can have a small size, and thus, the photoelectric conversion module 10 can achieve a performance of smaller thickness.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A photoelectric conversion module, comprising:
a circuit board;
a lens unit positioned on the circuit board; and
a photoelectric unit, the photoelectric unit electrically connected with the circuit board and optically coupled with the lens unit, wherein the circuit board defines a groove, the photoelectric unit is received in the groove.

2. The photoelectric conversion module of claim 1, wherein the lens unit comprises a first lens, a second lens, and a reflecting surface, the reflecting surface is configured for reflecting light passing through the first lens and the second lens.

3. The photoelectric conversion module of claim 2, wherein an optical axis of the first lens is perpendicular to and intersects with an optical axis of the second lens and an included angle between the reflecting surface and the first lens is 45 degrees.

4. The photoelectric conversion module of claim 1, wherein the circuit board is made of ceramic.

5. The photoelectric conversion module of claim 1, wherein the photoelectric unit comprises a light-emitting component and a light receiver.

6. The photoelectric conversion module of claim 5, wherein the light-emitting component is a light-emitting diode and the light receiver is a photo diode.

7. The photoelectric conversion module of claim 1, comprising a processor electrically connected with the photoelectric unit and located in the groove.
